(19) United States
(12) Patent Application Publication
(10) Pub. No.: US 2004/0070384 A1
(43) Pub. Date: Apr. 15, 2004

(54) Food-electricity measurement machine

(76) Inventor: Luis A. Gonzalez, Riverside, CA (US)

Correspondence Address: LUIS A. GONZALEZ, 4297 Pondhill Court, Riverside, CA, 92505, US

(21) Appl. No.: 10/206,969

(22) Filed: Nov. 27, 2002

Related U.S. Application Data
(60) Provisional application No. 60/308,849, filed on Aug. 1, 2001.

(51) Int. Cl. G01N 27/00

(52) U.S. Cl. 324/71.1

(57) ABSTRACT

The Food Electricity Measurement Machine consist of an empty battery box with six compartments that have broken insulated copper wires in each divider's wall. The compartments A,B,E, and F will have table salt in water solution. The compartments C and D will be used to add blended food. When an electrical current is send throughout those compartments, it will show if the food is a good conductor or electricity or not. Foods that increase the electrical power of the human body would help to increase the expectancy of life.

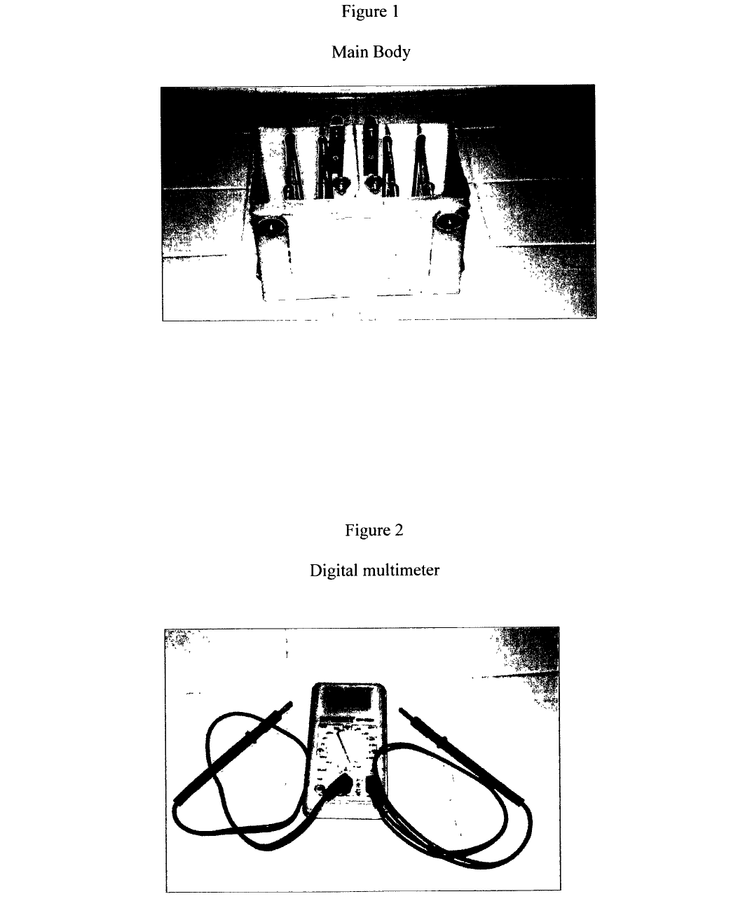

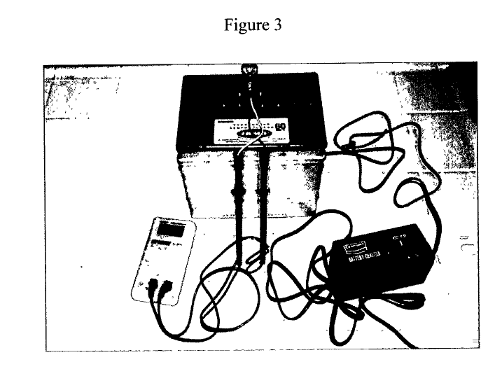

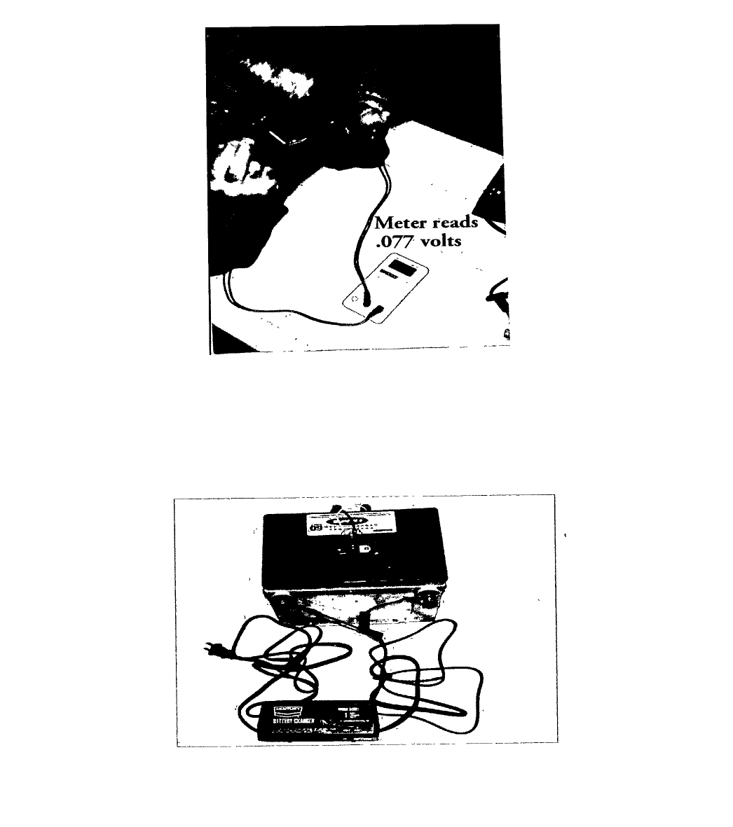

### BACKGROUND OF THE INVENTION

The present invention relates to a machine designed to measure if a specific food is or not a good conductor of electricity. The food that we eat could increase, reduce, or destroy the electrical power of the human body. The good food and the good or bad combination of food can maintain or destroy the electrical capacity of the human body. This means life or death, more or less years of life.

Ellen Gould (Harmon) White (1827-1915) is cofounder of the Seventh-day Adventist (SDA) church. She was a writer, lecturer, and counselor to the church who possessed what SDA's have accepted as the prophetic gift described in the Bible. The first weekend of June 1863, shortly after the organization of the General Conference of the SDA church (May, 1863), the Whites visited Otsego, Mich. There Mrs. White had a comprehensive vision, far reaching in its implications. It compassed the broad field of health and preventive medicine, and touched the high points of the causes of disease, the care of the sick, remedial agencies, nutrition, stimulants and narcotics, child care and healthful attire. The vision stressed the obligation of each person to give intelligent attention to health of the body and mind (SDA Encyclopedia p. 1406, 1409).

Mrs. White was inspired by God writing the following statements to us:

1. God gave electrical power to man at his creation

“God endowed man with so great vital force . . . This fact of itself is enough to evidence to us the strength and electrical energy that God gave to man at his creation” (Testimonies for the Church, Vol. 3, p. 138).

2. The nervous system conducts the electrical currents to the body

“The brain nerves which communicate with the entire system are the only medium through which Heaven can communicate to man and affect his inmost life. Whatever disturbs the circulation of the electrical currents in the nervous system lessens the strength of the vital powers, and the result is a deadening of the sensibilities of the mind” (Testimonies for the church, Vol. 2, p. 347).

3. The brain has electrical power

“The electrical power of the brain, promoted by mental activity, vitalizes the whole system, and is thus an invaluable aid in resisting disease” (Education, p. 197).

4. Erroneous eating and drinking result in erroneous thinking and acting.

“If the stomach is not properly cared for, the formation of an upright, moral character will be hindered. The brain and nerves are in sympathy with the stomach. Erroneous eating and drinking result in erroneous thinking and acting” (Counsels on Health, p. 134).

5. There is life in the seed.

“There is life in the seed, there is power in the soil; but unless an infinite power is exercised day and night, the seed will yield no returns. The showers of rain must be sent to give moisture to the thirsty fields, the sun must impart heat and electricity must be conveyed to the buried seed. The life, which the Creator has implanted, He alone can call forth. Every seed grows, every plant develops, by the power of God” (Christ Object Lessons, p. 63).

6. The system is vitalized by the electrical force of the brain to resist disease.

“The minds of thinking men labor too hard. They frequently use their mental powers prodigally, while there is another class whose highest aim in life is physical labor. The latter class does not exercise the mind. Their muscles are exercised while their brains are robbed of intellectual strength, just as the minds of thinking men are worked while their bodies are robbed of strength and vigor by their neglect to exercise the muscles. Those who are content to devote their lives to physical and leave others to do the thinking for them, while they simply carry out what other brains have planned, will have strength of muscle but feeble intellects. Their influence for good is small in comparison to what it might be if they would use their brains as well as their muscle. This class fall more readily if attacked by disease; the system is vitalized by the electrical force of the brain to resist disease” (Testimonies for the Church, Vol. 3, p. 157).

The person who is writing this accepts that God inspired the previous statements written by Mrs. White. This author wants to prove that we have foods that are better conductors of electricity than others already inside the human body.

### LIFE EXPENTANCY IN THE WORLD TODAY

The Bible presents a genealogy of the most important information about the age of those who lived on the earth after God created this world. It is as follows:

BIBLICAL GENEALOGY

| NAME | YEARS LIVED | REFERENCE |
|---|---|---|
| Methuselah | 969 | Genesis 5:27 |
| Jared | 962 | Genesis 5:20 |
| Adam | 930 | Genesis 5:5 |
| Seth | 912 | Genesis 5:8 |
| Cainan | 910 | Genesis 5:14 |
| Enos | 905 | Genesis 5:11 |
| Mahalaleel | 895 | Genesis 5:17 |
| Lamec | 779 | Genesis 5:31 |
| Henoch | 365 | Genesis 5:23 |

Today the life expectancy of humanity is much less. The country where men live more is Japan with 83 years. The Population Division of the United Nations Secretariat has a report of an estimate of the expected average number of years to be lived by a female or male newborn. Let's consider those countries where men and women live more and less years by regions.

LIFE EXPECTANCY IN DIFFERENT REGIONS OF THE WORLD

| COUNTRY OR AREA | WOMEN | MEN |
|---|---|---|
| AFRICA | | |
| Reunion | 80 | 71 |
| Uganda | 40 | — |
| Malawi | 40 | — |
| Sierra Leone | — | 36 |
| LATIN AMERICA/ | | |
| CARIBBEAN | | |
| Martinique | 82 | 76 |
| Guadeloupe | 81 | 74 |
| Barbados | — | 74 |
| Haiti | 56 | 51 |
| ASIA | | |
| Hong Kong SAR | 81 | 76 |
| Cyprus | 80 | 76 |
| Macao SAR | 80 | 75 |
| Afghanistan | 46 | 45 |
| OCEANIA | | |
| Guam | 77 | 73 |
| Papua New Guinea | 59 | 57 |
| Developed regions | | |
| Japan | 83 | 77 |
| Republic of Moldova | 72 | — |
| Russian Federation | — | 61 |

We can conclude based on evidence that the life of human beings is much less today than those who lived at the beginning of the earth. It is possible to develop different theories why people live less today. One theory to be considered is the diet. What we eat is key factor of why people live less or more in our world.

### A HEALTH PRINCIPLE UNDER CONSIDERATION

Adam, the first man who was created by God on earth lived 930 years (Genesis 5:5) compared to the overall estimate of the expected average number of years to be lived by a female (39 years) or a male (36 years) in Sierra Leone, Africa on 2000. (See United Nations Statistics Division, P. 2)

“The violation of physical law, and the consequence, human suffering, have so long prevailed that men and women look upon the present state of sickness, suffering, debility, and premature death as the appointed lot of humanity. Man came from the hand of his Creator perfect and beautiful in form, and so filled with vital force that it was more than thousand years before his corrupt appetite and passions, and general violations of physical law, were sensibly felt upon the race. More recent generations have felt the pressure of infirmity and disease still more rapidly and heavily with every generation. The vital forces have been greatly weakened by the indulgence of appetite and lustful passion. The patriarchs from Adam to Noah, with few exceptions, lived nearly a thousand years. Since the days of Noah the length of life has been tapering” (Testimonies for the Church, Vol. 3, p. 139).

God created man and woman with electrical power. The food that we eat could increase, reduce, or destroy the electrical power of the human body. We need to be very careful on what we eat or how we combine the different foods. The good food and the good or bad combination of food can maintain or destroy the electrical capacity of the human body. This means life or death, more or less years of life

### A DESCRIPTION OF THE HEALTH PRINCIPLE AND INTERVENTIONS

The diet is one of the fundamental principles that explain why people live more or less today. People have appetite to control their lives.

“Through the temptation to indulge appetite, Adam and Eve first fell from their high, holy, and happy state. And it is through the same temptation that the race had become enfeebled. They have permitted appetite and passion to take the throne, and to bring into subjection reason and intellect” (Testimonies for the Church, Vol. 3, p. 139).

The purpose of this research is to show that there are foods that are better conductors of electricity than others and, therefore, increase the life expectancy for the world today. The Food Energy Measurement Machine will help in this purpose. The Food Energy Measurement Machine is designed for future research and to help the people to choose the best foods that are better conductors of electricity in the human body.

### A REPORT OF THE HEALTH PRINCIPLE AND INTERVENTIONS

Jesus said, “You are the salt of the earth; but if salt has lost its taste, how shall its saltiness be restored? It is no longer good for anything except to be thrown out and trodden under foot by men” (Matthew 5:13).

Jesus command “Have salt in yourself” (Mark 9:50; cf. Col. 4:6), enjoins the mutual loyalty of the covenant relationship; his description of the disciples as the “salt of the earth” (Matthew 5:13) is probably connected with the above-mentioned life-giving qualities of salt. The prediction “Every one will be salted with fire” (Mark 9:49) refers to the sacrifice involved in the coming judgment. (The Interpreter's Dictionary of the Bible, Vol. 4, p. 167).

The salt has life-giving qualities to the world. When Jesus said, “You are the salt of the earth,” not only brings a spiritual lesson on the role of the Christians on the world, but He also presents a scientific view of the earth. There is salt on the earth. This means that the foods from the earth that we eat contain salt. It is not necessary to add table salt to those foods coming from nature, because the food that we eat already has natural salt in it from the earth plus the accumulation of electricity from the sun. In previous experiments the table salt mixed in water solution is a good conductor of electricity.

### SUMMARY OF THE INVENTION

God sends his electrical power to the earth from the sun. The earth and the sea have salt. This natural chemical element help to bring life to the plants. All the fruits, vegetables and legumes are a concentration of electric power and serve to maintain the electric power in the human body.

The machine has the purpose to prove the fact that the food is a good conductor of electricity. Some foods have the property of conducting the electricity in our human body more than others.

The Food Energy Measurement Machine will provide information on the watts contained in the food when it is submitted to the process of the liberation of energy. This machine is designed in the following way. It is an empty auto battery box (8¾ inches long by 6½ inches wide) with 6 compartments (6½ inches long, 1½ inches wide, and 7 inches deep). These six compartments have divider's walls with broken insulated copper wires in each compartment. Also, two copper bars connected to two banana posts. There is a Digital Multimeter connected at the end of the battery box. An on/off switch will be connected to the front of the empty battery box. A battery charger will be used to send the electrical current through the device when it is in operation.

1) Main Body

This machine is designed in the following way. It is an empty auto battery box (8¾ inches long by 6 1/2 inches wide) with 6 compartments (6½ inches long, 1½ inches wide, and 7 inches deep). These six compartments have divider's walls with broken insulated copper wires in each compartment. Also, two copper bars connected to two banana posts.

The machine will have six compartments. We will call them A, B, C, D, E, & F. The compartments A, B, E, and F will have table salt in water solution. The compartments C and D will be used to add blended food. If we send an electrical current throughout those compartments, it will show if the food is a good conductor of electricity or not.

2) Digital Multimeter connected at the end of the battery box. This is Model DM-350 A. The idea is to connect this or any other digital device at the end of the box.

3) An on/off switch will be connected to the front of the empty battery box. A battery charger will be used to send the electrical current through the device when its in operation.

### EXPERIMENTS

The foods contain water, sugar, and salt, on its natural way. Let's make experiments to some of them:

| | | | Volts |
|---|---|---|---|
| | | Liquid, solid or mix | Enter/(Exit) |
| 1) | Pure Water | Liquid | 14/(14) |
| 2) | Table Salt | Solid | 15/(12) |
| 3) | Sea Salt with | Mix | 14/(14) |
| | Water | | |
| 4) | Granulated sugar | Solid | 14/(11) |
| 5) | Sugar with water | Mix | 14/(14) |
| 6) | Fresh Pink | Liquid | 14/(14) |
| | grapefruit juice | | |
| 7) | Natural carrot | Liquid | 15/(15) |
| | juice | | |
| 8) | Soy Milk | Liquid | 13/(13) |
| 9) | Tomatoes | Solid | 12/(12) |
| 10) | Cooked rice with | Solid | 12/(12) |
| | tomatoes and corn | | |
| 11) | Refined white | Solid | 14/(0) |
| | flour | | |

### CONCLUSIONS

These are some of the facts found out from the experiments. The brain produces electricity. A digital multimeter placed on both sides of the brain will prove the above stated fact.

1. What I claim as my invention is the Food Electricity Measurement Machine: an empty battery box with six compartments. These compartments have divider's walls with broken insulated copper wires in each compartment. There is a Digital Multimeter attached to it, and an on/off switch. This machine will measure if particular foods are or not good conductors of electricity.
